(19) United States
(12) Patent Application Publication
(10) Pub. No.: US 2016/0225038 A1
(43) Pub. Date: Aug. 4, 2016

(54) METHOD AND SCORE MANAGEMENT NODE FOR SUPPORTING SERVICE EVALUATION WITH CONSIDERATION TO A USER'S FADING MEMORY

(71) Applicant: Telefonaktiebolaget L M Ericsson (publ), Stockholm (SE)

(72) Inventor: Joerg NIEMOELLER, Sundbyberg (SE)

(21) Appl. No.: 14/611,396

(22) Filed: Feb. 2, 2015

(51) Int. Cl. G06Q 30/02; H04W 8/20

(52) U.S. Cl. CPC G06Q 30/0282; H04W 8/205

(57) ABSTRACT

A method and a score management node for supporting service evaluation by obtaining a perception score reflecting an individual user's experience of a service delivered by means of a telecommunication network. When receiving network measurements related to service events when the service is delivered to the user, the score management node determines, for each service event, a quality score reflecting the user's perception of quality of service delivery and an associated significance reflecting the user's perception of importance of the service delivery, based on the network measurements. The significance is reduced over time according to a Significance Reduction Rate, SRR, reflecting the user's fading memory of the service events, and the perception score is calculated as an average of the quality scores weighted by their associated significances, wherein the calculated perception score is made available for use in the service evaluation.

### TECHNICAL FIELD

The present disclosure relates generally to a method and a score management node for supporting service evaluation based on a perception score P reflecting a user's experience of a service delivered by means of a telecommunication network.

### BACKGROUND

When a service has been delivered by means of a telecommunication network by a service provider to one or more users, it is of interest for the service provider to know whether the user is satisfied with the delivered service or not, e.g. to find out if the service has shortcomings that need to be improved in some way to make it more attractive to this user and to other users. Service providers, e.g. network operators, are naturally interested in making their services as attractive as possible to users in order to increase sales, and a service may therefore be designed and developed so as to meet the users' demands and expectations as far as possible. It is therefore useful to gain knowledge about, the users' opinion after service delivery in order to evaluate the service. The services discussed in this disclosure may, without limitation, be related to streaming of audio and visual content e.g. music and video, on-line games, web browsing, file downloads, voice and video calls, delivery of information such as files, images and notifications, and so forth, i.e. any service that can be delivered by means of a telecommunication network.

A normal way to obtain the users' opinion about a delivered service is to explicitly ask the customer, after delivery, to answer certain questions about the service in a survey or the like. For example, the service provider may send out or otherwise present an inquiry form, questionnaire or opinion poll to the customer with various questions related to user satisfaction of the service and its delivery. If several users respond to such a poll or questionnaire, the results can be used for evaluating the service, e.g. for finding improvements to make, provided that the responses are honest and that a significant number of users have answered. An example of using survey results is the so-called Net Promoter Score, NPS, which is calculated from answers to user surveys to indicate the users' collected opinions expressed in the survey answers.

However, it is often difficult to motivate a user to take the time and trouble to actually answer the questions and send a response back to the service provider. Users are often notoriously reluctant to provide their opinions on such matters, particularly in view of the vast amounts of information and questionnaires flooding users in the current modern society. One way to motivate the user is to reward him/her in some way when submitting a response, e.g. by giving some present or a discount either on the purchased services or when buying future services, and so forth.

Even so, it is a problem that surveys can in practice only be conducted for a limited number of users which may not be representative for all users of a service, and that the feedback cannot be obtained in “real-time”, that is immediately after service delivery. A survey should not be sent to a user too frequently either. The obtained feedback may thus get out-of-date.

Further problems include that considerable efforts must be spent to distribute a survey to a significant but still limited number of users and to review and evaluate all answers coming in, sometimes with poor results due to low responsiveness. Furthermore, the user may provide opinions which are not really accurate or honest and some responses to surveys may even be misleading. For example, the user is often prone to forget how the service was actually perceived or experienced when it was delivered, even after a short while, once prompted to respond to a questionnaire. Human memory thus tends to change over time, and the response given may not necessarily reflect what the user really felt and thought at service delivery. The user may further provide the response very hastily and as simply as possible not caring much if it really reflects their true opinion. The opinion expressed may also be dependent on the user's current mood such that different opinions may be expressed at different occasions, making the response all the more erratic and unreliable.

Still another problem is that it can be quite difficult to trace an underlying reason why users have been dissatisfied with a particular service, so as to take actions to eliminate the fault and improve the service and/or the network used for its delivery. Tracing the reason for such dissatisfaction may require that any negative opinions given by users need to be correlated with certain operational specifics related to network performance, e.g. relating to where, when and how the service was delivered to these users. This kind of information is not generally available and analysis of the network performance must be done manually by looking into usage history and history of network issues. Much efforts and costs are thus required to enable tracing of such faults and shortcomings.

### SUMMARY

It is an object of embodiments described herein to address at least some of the problems and issues outlined above. It is possible to achieve this object and others by using a method and a score management node as defined in the attached independent claims.

According to one aspect, a method is performed by a score management node for supporting service evaluation by obtaining a perception score P reflecting an individual user's experience of a service delivered by means of a telecommunication network. In this method the score management node receives network measurements related to service events when the service is delivered to the user. The score management node determines, for each service event, a quality score Q reflecting the user's perception of quality of service delivery and an associated significance S reflecting the user's perception of importance of the service delivery, based on said network measurements. The score management node further reduces the determined significance S over time according to a Significance Reduction Rate, SRR, reflecting the user's fading memory of the service events, and calculates the perception score P as an average of the quality scores Q weighted by their associated significances S, wherein the calculated perception score P is made available for use in the service evaluation.

According to another aspect, a score management node is arranged to support service evaluation by obtaining a perception score P reflecting an individual user's experience of a service delivered by means of a telecommunication network. The score management node comprises a processor and a memory containing instructions executable by the processor, whereby the score management node is configured to:
receive network measurements related to service events when the service is delivered to the user,
determine, for each service event, a quality score Q reflecting the user's perception of quality of service delivery and an associated significance S reflecting the user's perception of importance of the service delivery, based on said network measurements,
reduce the determined significance S over time according to a Significance Reduction Rate, SRR, reflecting the user's fading memory of the service events, and
calculate the perception score P as an average of the quality scores Q weighted by their associated significances S, wherein the calculated perception score P is made available for use in the service evaluation.

Thereby, the perception score P can be used in the service evaluation as an estimation of the users' opinion particularly since P is adapted to the user's fading memory of each service event over time, and it is possible to obtain P automatically after every time a service is delivered to the user. Further, the perception score P is calculated from technical measurements in the network related to the service usage which are readily available for any user and it is thus not necessary to depend on the user to answer a survey or the like.

The above method and score management node may be configured and implemented according to different optional embodiments to accomplish further features and benefits, to be described below.

A computer program storage product is also provided comprising instructions which, when executed on at least one processor in the score management node, cause the at least one processor to carry out the method described above for the score management node.

### BRIEF DESCRIPTION OF DRAWINGS

The solution will now be described in more detail by means of exemplary embodiments and with reference to the accompanying drawings, in which:

FIG. 1 is a block diagram illustrating an example of how a score management node may be configured and operate, according to some possible embodiments.

FIG. 2 is a flow chart illustrating a procedure in a score management node, according to further possible embodiments.

FIG. 3 is a diagram illustrating an example of how significance S may be reduced over time from an initial value of 1, according to further possible embodiments.

FIG. 4 is a table illustrating some examples of fading memory parameters for different service types, according to further possible embodiments.

FIG. 5 is a block diagram illustrating an example of how a score management node may be configured, according to further possible embodiments.

FIG. 6 is a flow chart illustrating an example of a more detailed procedure in a score management node, according to further possible embodiments.

FIG. 7 is a flow chart illustrating another example of a procedure in a score management node, according to further possible embodiments.

FIG. 8 is a block diagram illustrating an example of how a score management node may operate in practice, according to further possible embodiments.

### DETAILED DESCRIPTION

The embodiments described in this disclosure can be used for supporting evaluation of a service by obtaining an estimated user opinion about the service when it has been delivered to a specific user by means of a telecommunication network. In particular, the user's fading memory of previous service events over time is taken into account in a manner to be described herein. The embodiments will be described in terms of functionality in a “score management node”. Although the term score management node is used here, it could be substituted by the term “score management system” throughout this disclosure.

Briefly described, a perception score P is calculated that reflects the user's experience of the service, based on one or more technical network measurements made for events or occasions when the service was delivered to the user, hereafter referred to as “service events” for short, which measurements are received by the score management node. For example, the network measurement(s) may relate to the time needed to download data, the time from service request until delivery, call drop rate, data rate and data error rate.

In this solution it has been recognized that a user's memory of service events tends to fade over time and that this can be compensated by reducing the significance of each service event over time accordingly. Some examples of how this can be done will be described below. This solution may be used for obtaining a perception score P which has been adapted according to an estimation of the user's fading memory.

In the following description, any network measurements related to delivery of a service to the user by means of a telecommunication network are generally denoted “v” regardless of measurement type and measuring method. It is assumed that such network measurements v are available in the network, e.g. as provided from various sensors, probes and counters at different nodes in the network, which sensors, probes and counters are already commonly used for other purposes in telecommunication networks of today, thus being operative to provide the network measurements v to the score management node for use in this solution. Key Performance Indicator, KPI, is a term often used in this field for parameters that in some way indicate network performance.

Further, the term “delivery of a service by means of a telecommunication network” may be interpreted broadly in the sense that it may also refer to any service delivery that can be recorded in the network by measurements that somehow reflect the user's experience of the service delivery. Some further examples include services provided by operator personal aided by an Operation and Support System, OSS, infrastructure. For example, “Point of sales” staff may be aided by various software tools for taking and executing orders from users. These tools may also be able to measure KPIs related to performance of the services. Another example is the Customer Care personal in call centers who are aided by some technical system that registers various user activities. Such technical systems may as well make network measurements related to these activities as input to the score management node.

For example, the network measurements v may be sent regularly from the network to the score management node, e.g. in a message using the hyper-text transfer protocol http or the file transfer protocol ftp over an IP (Internet Protocol) network. Otherwise the score management node may fetch the measurements v from a measurement storage where the network stores the measurements. In this disclosure, the term network measurement v may also refer to a KPI which is commonly prepared by the network to reflect actual physical measurements. The concept of KPIs is well-known as such in telecommunication networks.

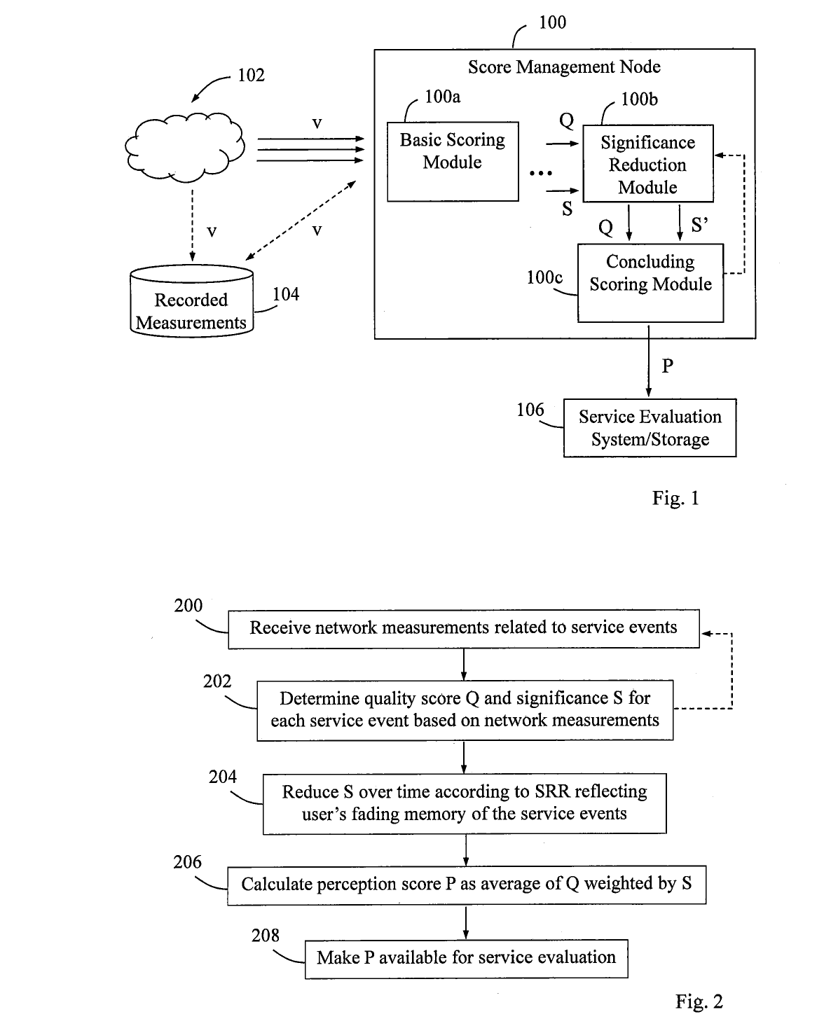

The perception score P is generated by the score management node as follows and with reference to FIG. 1 which illustrates a score management node 100 which receives network measurements v made in a telecommunication network 102 as related to service events when the service is delivered to the user. The network measurements v may be sent from the network 102 to the score management node 100 more or less in real-time in a “live stream” fashion as the service events occur, e.g. from an Operation & Maintenance, O&M, node or similar, not shown. Alternatively, the network measurements v may be recorded by the network 102 and stored in a suitable storage or database 104, as indicated by a dashed one-way arrow from the network 102, which information can be accessed by the score management node 100, e.g. at regular intervals, as indicated by a dashed two-way arrow.

The received network measurements v can be seen as “raw data” being used as input in this procedure. For example, the above O&M node may be an aggregation point or node for distributed sensors and probes that make measurements in the traffic flows throughout the network. This node may combine, correlate and potentially filter the measurement data, e.g. to produce KPIs or the like.

A quality score Q reflecting the user's perception of quality of a delivered service and an associated significance S reflecting the user's perception of importance of the delivered service, are determined for each service event by a “basic scoring module” 100a, based on the received network measurements. Q and S are thus determined as pertaining to a single service event and the user's experience of that service event. Q and S may be determined for each service event by applying predefined functions on each received network measurement, which will be explained in more detail later below. The perception score P is calculated by a “concluding scoring module” 100c from quality scores Q of multiple service events which are weighted by their associated significances S. Basically, the greater significance S the greater influence has the associated quality score Q on the resulting perception score P.

The perception score P is basically calculated by the score management node for multiple service events as an average of the quality scores Q for those service events weighted by their respective significances S, which can be expressed according to the following formula for calculating the perception score P_{N} for N service events as

$${P}_{N} = \frac{{\sum }_{n = 1}^{N} {Q}_{n} {S}_{n}}{{\sum }_{n = 1}^{N} {S}_{n}}$$

where Qₙ is the quality score for each service event n and Sₙ is the associated significance for said service event n. In other words, the total perception score P_{N} is the sum of all quality scores Q weighted by significances S divided by a total sum of significances S, here called the “S sum” for short.

As mentioned above, this solution takes into account that the user tends to forget a service event as time goes by and the fading memory of the user is thus a factor that will influence the resulting perception score P so that the significance and impact of a service event decays over time, which may be realized in different ways to be described herein. For example, the significance S determined for a service event may be reduced by a “significance reduction module” 100b over time in a step-like fashion according to a certain Significance Reduction Rate, SRR, reflecting the user's fading memory of the service event. S may thus be reduced for each service event gradually, i.e. step by step, after the service event took place and P will thereby change accordingly to simulate that the user in due course forgets about the service event. The perception score P may be re-calculated, i.e. updated, after each reduction of S for a service event. Examples of how the SRR may be obtained and used for the reduction of S will be described later below.

Another possibility is to first calculate P for multiple service events and then reduce the sum of significances S of all these service events over time and re-calculate or update P after each reduction of the S sum based on the reduced S sum. The above formula is an example of how P can be calculated and how P is dependent on the S sum. If no new service event occurs the S sum will finally reach zero and P will not be impacted by the above multiple service events, thus indicating that these service events have presumably been forgotten by the user altogether. However, each time a new service event occurs, a new sum of significances S will be determined which is higher than the previous S sum by adding S of the new service event to the S sum, and the reduction of S sum will therefore start again from the higher value. This means that the S sum can only be reduced to zero if no new service event occurs before the previous service events are assumed to be forgotten.

The score management node 100 may comprise other scoring modules 100a as well for adjusting Q and S depending on other influencing factors, as indicated by a dotted line, which is however outside the scope of this solution. Having generated the resulting perception score P, the score management node 100 makes P available for evaluation of the service, e.g. by saving it in a suitable storage or sending it to a service evaluation system or center, schematically indicated by numeral 108. For example, P may be sent to the service evaluation system or storage 108 in an http message or an ftp message over an IP network. The service evaluation system or storage 108 may comprise an SQL (Structured Query Language) database or any other suitable type of database.

By reducing the significance S over time to simulate the user's fading memory of the service events, the impact of these service events on the perception score P will decay over time until their impact reaches zero assuming that the service events are virtually forgotten by the user at this point. This disclosure is directed to describe how the above user-specific perception score P can be obtained depending on the time elapsed after one or more service events, among other things, according to some illustrative but non-limiting examples and embodiments. By using this solution, the perception score P can be seen as a model for how a specific user is expected to perceive and remember the service when taking the user's fading memory into account, which model is based on objective and technical network measurements.

There are several advantages of this solution as compared to conventional ways of obtaining a user's expected opinion about a service. First, the perception score P is a quite accurate estimation of the users' opinion of the service event since it takes the user's fading memory of previous service events into account by gradually reducing the impact of “old” service events over time, and it is possible to obtain P automatically and continuously in real-time for any user, basically after every time a service is delivered to a user. There are thus no restrictions regarding the number of users nor the extension of time which makes it possible to obtain a quite representative perception score P that is adapted to account for the user's fading memory of “old” service events.

Second, the perception score P is calculated from technical measurements in the network related to the service usage which are truthful and “objective” as such, also being readily available, thereby avoiding any dependency on the user's memory and willingness to answer a survey or the like. Third, it is not necessary to spend time and efforts to distribute surveys and to collect and evaluate responses, which may require at least a certain amount of manual work.

Fourth, it is also possible to gain further knowledge about the service by determining the perception score P selectively, e.g. for specific types of services, specific types of network measurements, specific users or categories of users, and so forth. Fifth, it is also possible to trace a technical issue that may have caused a “bad” experience of a delivered service by identifying which measurement(s) have generated a low perception score P. It can thus be determined when and how a service was delivered to a presumably dissatisfied user, as indicated by the perception score P, and therefore a likely technical shortcoming that has caused the user's dissatisfaction can also be more easily identified. Once found, the technical issue can easily be eliminated or repaired. Different needs for improvement of services can also be prioritized based on the knowledge obtained by the perception score P. Further features and advantages will be evident in the description of embodiments that follows.

An example of how the solution may be employed will now be described with reference to the flow chart in FIG. 2 which illustrates a procedure with actions performed by a score management node, to accomplish the functionality described above. The score management node is operative to support service evaluation based on a perception score P reflecting a user's experience of a service delivered by means of a telecommunication network, e.g. in the manner described above for the score management node 100. In particular, this procedure produces a perception score P that is adapted to the user's fading memory of service events over time.

A first action 200 illustrates that the score management node receives network measurements from the network related to service events when the service is delivered to the user. Thus, a network measurement is received basically each time the service is delivered to the user and this network measurement is used as a basis for estimating how the user has experienced this particular service event. This action thus refers to several service events. This operation may be performed in different ways, e.g. when the network sends a stream of network measurements as they are generated, or by fetching network measurements from a measurement storage, as described above. Action 200 may thus be executed continuously or regularly any time during the course of this process of the following actions. The protocol used in this communication may be the hyper-text transfer protocol http or the file transfer protocol ftp, and the network measurements may be received in a message such as a regular http message or ftp message.

In some possible embodiments, the score management node may thus receive the network measurements in a message according to the hyper-text transfer protocol http or the file transfer protocol ftp. In some further possible but non-limiting embodiments, the network measurements may be related to any of: the time needed to download data, the time from service request until delivery, call drop rate, data rate, and data error rate.

In a next action 202, the score management node determines, for each service event, a quality score Q reflecting the user's perception of quality of service delivery and an associated significance S reflecting the user's perception of importance of the service delivery, based on said network measurements. It was mentioned above that Q and S may be determined by applying predefined functions comprising the user-specific model parameters on each respective network measurement v. For example, Q may be determined by applying a first predefined function Q(v) on the network measurement v, and S may be determined by applying a second predefined function S(v) on the network measurement v. The first and second functions are thus different functions configured to produce suitable values of Q and S, respectively.

Further, the first and second predefined functions Q(v) and S(v) are dependent on a type of the network measurement so that a function applied on, say, measurement of data rate is different from a function applied on measurement of call drop rate, to mention two non-limiting but illustrative examples. In this way, a pair of Q and associated S is obtained for each network measurement of a service event. A dashed arrow indicates that actions 200 and 202 may thus be repeated whenever a network measurement is received for a service event.

In a further action 204, the score management node reduces the determined significance S over time according to a Significance Reduction Rate, SRR, reflecting the user's fading memory of the service events. This may be performed in several different ways. In a possible embodiment, the score management node may reduce the significance S according to the SRR at regular intervals, which can be done according to suitable configuration parameters as follows. Thus in further possible embodiments, the score management node may calculate the SRR from a predefined Reduction Time Interval, RTI, and a predefined Time to Zero parameter, TTZ, as

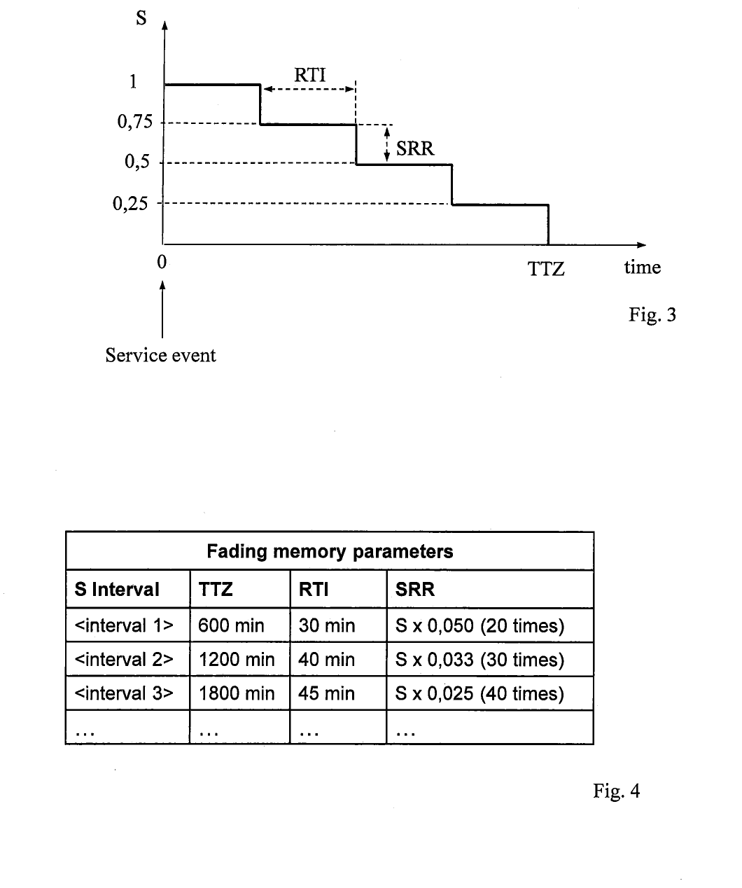

SRR=S·RTI/TTZ

where RTI is a time interval between reductions of the significance S and TTZ is a time from the service events until the significance S reaches zero. In other words, RTI indicates how often S is reduced and TTZ indicates for how long the service event is remembered by the user, according to this model. FIG. 3 illustrates an example of how these parameters may be related where a service event produces a significance of 1 which is reduced over time until TTZ is reached. In this simplified example, S is reduced 4 times by 0.25 at each RTI. Since TTZ and RTI are predefined and known, SRR can be calculated according to the above formula. In another embodiment, the score management node may reduce the determined significance S by subtracting SRR after each RTI, e.g. as shown in FIG. 3. Further alternative embodiments for how S can be reduced will be described below.

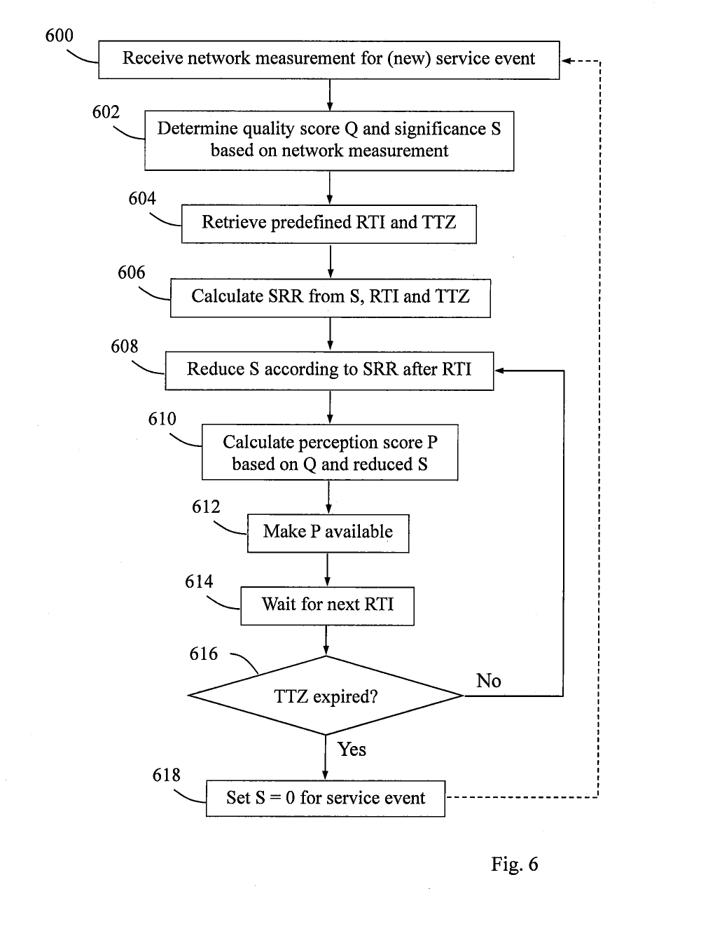

In one possible alternative embodiment, the score management node may reduce the significance S of each respective service event separately over time according to the SRR, and calculates the perception score P as an average of the quality scores Q for the service events weighted by their associated separately reduced significances S. A more detailed example of how this might be performed will be described later below with reference to FIG. 6. The perception score P may be updated after each reduction of a significance of a service event, or P may be updated after a certain number of S reductions, and this embodiment is not limited in this respect.

It is also possible to reduce the significance S over time for more than one service event by reducing S jointly for multiple service events at the same time. Thus in another possible alternative embodiment, the score management node may reduce a sum of the significances S for multiple service events over time and calculate the perception score P as a sum of the quality scores Q for the service events weighted by the reduced sum of significances S. In that case, the score management node may, according to another possible embodiment, update the perception score P after a new service event as a weighted average of the perception score P and a quality score Q of the new service event, add the significance S of the new service event to the sum of significances S and update the SRR based on the new sum of significances S which is then reduced over time according to the updated SRR.

The above embodiment of updating the perception score P after a new service event can be seen as an incremental update of P each time a service event has occurred and a new network measurement has been received from the network. In more detail, this incremental update of P may be performed as follows.

The score management node may update the perception score P after a new service event n based on a previous perception score Pₙ₋₁ calculated for a previous time interval or service event and a quality score Qₙ and associated significance Sₙ determined for the new service event n, according to the following formula:

$${P}_{n} = \frac{{P}_{n - 1} {S}_{sum , n - 1} + {Q}_{n} {S}_{n}}{{S}_{sum , n - 1} + {S}_{n}}$$

where S_{sum,n}=S_{sum,n-1}+Sₙ and Pₙ is the updated perception score. The updated perception score Pₙ is thus calculated as a weighted average of the previous perception score Pₙ₋₁ and the new quality score Qₙ. In this way, the perception score P can be kept up-to-date after each new service event by using the above simple calculation which adds the influence of the new service event n on the total P by means of the parameter Sₙ while the significance of the previous service events is reduced by reducing the sum of significances Sₛᵤₘ over time according to the updated SRR.

In order to reduce the significance with further accuracy, it is also possible to use different values of the parameter TTZ to reflect that the user is inclined to remember service events of high significance longer than service events of low significance, by dividing the multiple service events into different sets of service events, which may be referred to as different “memory lanes”, where the significance is reduced over different lengths of time, i.e. with a different TTZ in each memory lane. Thereby the service events can be classified into, e.g. long-term remembrance, short-term remembrance and any lengths of remembrance for which partial perception scores can be calculated separately as follows.

A partial perception score Pp is calculated for each memory lane and a total perception score P is then calculated as an average of the partial perception scores Pp, which may be a weighted average. The term “memory lane” is used here as referring to the user's remembrance of service events that produce a significance value within a certain interval. The total perception score P can be made more accurate by calculating it from two or more partial perception scores Pp determined separately for different sets of service events depending on the value of S being within different intervals.

For example, one set of service events that has produced relatively low values of S, e.g. when S is within a first interval, can be given a relatively short TTZ which will produce a high Significance Reduction Rate, SRR according to the above formula, to reflect that the user forgets those service events rapidly. On the other hand, another set of service events that has produced relatively high values of S, e.g. when S is within a second interval higher than the first interval, can be given a longer TTZ which will produce a low Significance Reduction Rate, SRR to reflect that the user remembers those service events for a longer time. The first and second interval may also be defined as being below and above, respectively, a predefined significance threshold.

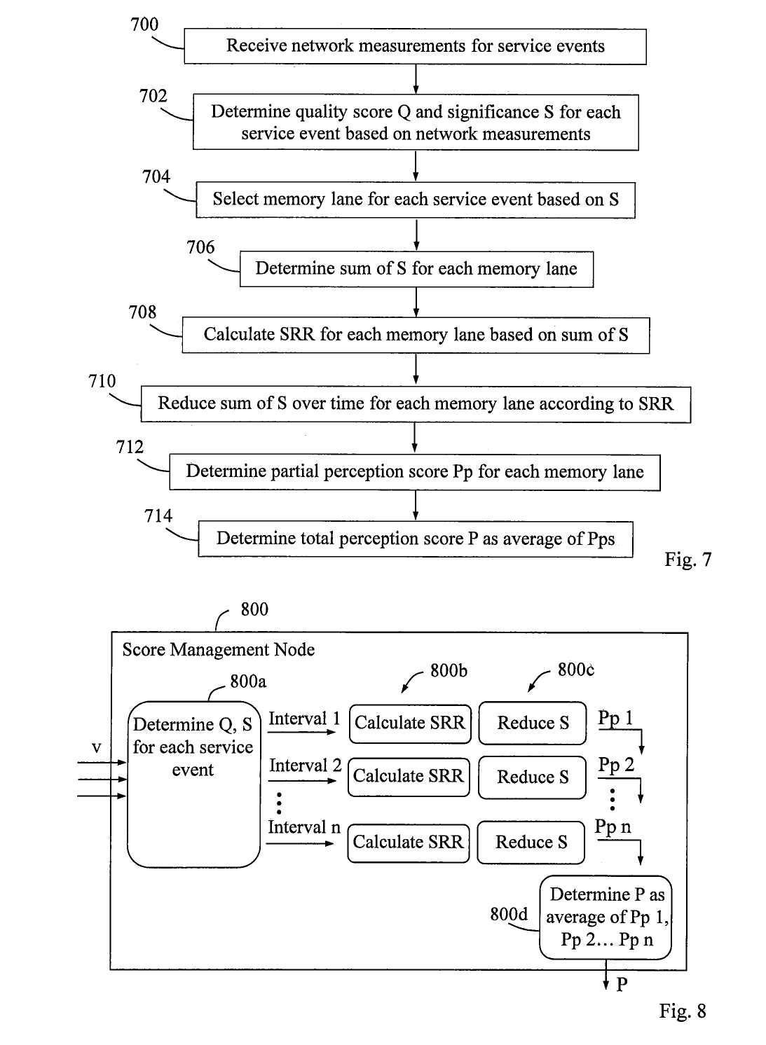

In yet another possible embodiment, the score management node may thus calculate at least a first partial perception score Pp for service events with significance S below a predefined significance threshold and a second partial perception score Pp for service events with significance S above the predefined significance threshold, and calculate the perception score P as an average of the at least first and second partial perception scores Pp. The number of partial perception scores is however not limited to two. In another possible embodiment, the score management node may calculate multiple partial perception scores Pp for different service events with significance S within different intervals, based on corresponding partial sums of the significances S which are reduced over time according to respective SRRs, and calculate the perception score P as an average of the multiple partial perception scores Pp. A more detailed example of how this might be performed will be described later below with reference to FIGS. 7 and 8.

In another action 206, the score management node calculates the perception score P as an average of the quality scores Q weighted by their associated significances S. In another possible embodiment, the score management node may calculate the perception score P_{N} for N service events as

$${P}_{N} = \frac{{\sum }_{n = 1}^{N} {Q}_{n} {S}_{n}}{{\sum }_{n = 1}^{N} {S}_{n}}$$

where Qₙ is the quality score for each service event n and Sₙ is the associated significance for said service event n.

Finally, the calculated perception score P is made available for use in the service evaluation, as illustrated by an action 208, e.g. by saving it in a suitable storage or sending it to a service evaluation system or center, as also indicated by numeral 106 in FIG. 1. The protocol used in this communication may be e.g. the hyper-text transfer protocol http or the file transfer protocol ftp, and the perception score P may be sent to the service evaluation system or storage in an http message or an ftp message over an IP network. The service evaluation system or storage may comprise an SQL (Structured Query Language) database or any other suitable type of database.

It was mentioned above that the service events may be distributed or divided into different memory lanes where the significance is reduced over different lengths of time, i.e. with different TTZs and that a partial perception score Pp can be calculated for each memory lane so that all partial perception scores make up the total partial perception score P. A table shown in FIG. 4 illustrates some examples of the parameters TTZ, RTI and SRR for different intervals of the significance S, which will determine how S should be reduced over time for different memory lanes with Q and S for service events depending on the value of S. It should be noted that the memory lanes have different values of TTZ for different S intervals, thus reflecting that service events of high significance S are remembered by the user for longer time than service events of low significance S.

As mentioned above, a partial perception score Pp is calculated for the service events of each memory lane and a total perception score P is calculated as an average of all the partial perception scores Pp. The pattern for reducing S over time in each memory lane will basically be as illustrated in FIG. 3 but divided into a greater number of reduction occasions before TTZ is reached. Thus, service events producing values of S below a first significance threshold, thus being within interval 1, are assumed to be forgotten after TTZ=600 minutes. The significance S of this memory lane is suitably reduced at each RTI of 30 minutes, i.e. 20 times in all. Further, service events producing values of S between the first significance threshold and a higher second significance threshold, thus being within interval 2, are assumed to be forgotten after TTZ=1200 minutes. The significance S of this memory lane is suitably reduced at each RTI of 40 minutes, i.e. 30 times in all. Further, service events producing values of S between the second significance threshold and a higher third significance threshold, thus being within interval 3, are assumed to be forgotten after TTZ=1800 minutes. The significance S of this memory lane is suitably reduced at each RTI of 45 minutes, i.e. 40 times in all.

It should be noted that TTZ and RTI may be predetermined to any suitable values and the SRR can be calculated for a determined value of S from these TTZ and RTI values according to the above formula. In this simplified but illustrative example, Interval 3 is merely 3 times as long as interval 1 but in practice much greater differences of interval length may be used in order to distinguish short term human memory and long term memory. Another perhaps more practical example of TTZ values may thus be 24 hours for interval 1, 7 days for interval 2 and 1 month for interval 3.

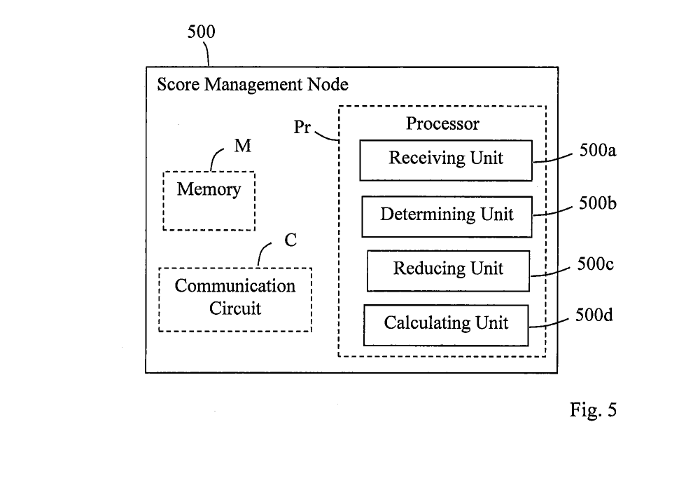

The block diagram in FIG. 5 illustrates another detailed but non-limiting example of how a score management node 500 may be structured to bring about the above-described solution and embodiments thereof. In this figure, the score management node 500 may thus be configured to operate according to any of the examples and embodiments of employing the solution as described above, where appropriate, and as follows. The score management node 500 in this example is shown in a configuration that comprises a processor “Pr”, a memory “M” and a communication circuit “C” with suitable equipment for receiving and transmitting information and data in the manner described herein.

The communication circuit C in the score management node 500 thus comprises equipment configured for communication with a telecommunication network, not shown, using one or more suitable communication protocols such as http or ftp, depending on implementation. As in the examples discussed above, the score management node 500 may be configured or arranged to perform at least the actions of the flow chart illustrated in FIG. 2 in the manner described above. These actions may be performed by means of functional units in the processor Pr in the score management node 500 as follows.

The score management node 500 is arranged to support service evaluation by obtaining a perception score P reflecting an individual user's experience of a service delivered by means of a telecommunication network. The score management node 500 thus comprises the processor Pr and the memory M, said memory comprising instructions executable by said processor, whereby the score management node 500 is operable as follows.

The score management node 500 is configured to receive network measurements related to service events when the service is delivered to the user. This receiving operation may be performed by a receiving unit 500a in the score management node 500, e.g. in the manner described for action 200 above. The score management node 500 is also configured to determine, for each service event, a quality score Q reflecting the user's perception of quality of service delivery and an associated significance S reflecting the user's perception of importance of the service delivery, based on the received network measurements. This determining operation may be performed by a determining unit 500b in the score management node 500, e.g. in the manner described for action 202 above.

The score management node 500 is also configured to reduce the determined significance S over time according to a Significance Reduction Rate, SRR, reflecting the user's fading memory of the service events. This reducing operation may be performed by a reducing unit 500c in the score management node 500, e.g. in the manner described for action 204 above. The score management node 500 is also configured to calculate the perception score P based on the quality scores Q and associated significances S, wherein the calculated perception score P is made available for the service evaluation. This calculating operation may be performed by a calculating unit 500d in the score management node 500, e.g. in the manner described for action 206 above.

It should be noted that FIG. 5 illustrates some possible functional units in the score management node 500 and the skilled person is able to implement these functional units in practice using suitable software and hardware. Thus, the solution is generally not limited to the shown structure of the score management node 500, and the functional units 500a-d may be configured to operate according to any of the features described in this disclosure, where appropriate.

The embodiments and features described herein may thus be implemented in a computer program storage product comprising instructions which, when executed on at least one processor, cause the at least one processor to carry out the above actions e.g. as described for any of FIGS. 1-8. Some examples of how the computer program storage product can be realized in practice are outlined below, and with further reference to FIG. 5.

The processor Pr may comprise a single Central Processing Unit (CPU), or could comprise two or more processing units. For example, the processor Pr may include a general purpose microprocessor, an instruction set processor and/or related chips sets and/or a special purpose microprocessor such as an Application Specific Integrated Circuit (ASIC). The processor Pr may also comprise a storage for caching purposes.

The memory M may comprise the above-mentioned computer readable storage medium or carrier on which the computer program is stored e.g. in the form of computer program modules or the like. For example, the memory M may be a flash memory, a Random-Access Memory (RAM), a Read-Only Memory (ROM) or an Electrically Erasable Programmable ROM (EEPROM). The program modules could in alternative embodiments be distributed on different computer program products in the form of memories within the score management node 500.

It was mentioned above that the significance S of each respective service event may be reduced separately, i.e. individually, over time according to the SRR, and that the perception score P can then be calculated as an average of the quality scores Q for the service events weighted by their associated separately reduced significances S. FIG. 6 illustrates a procedure of how this might be performed with action performed by a score management node. In a first action 600, the score management node receives a network measurement which has been made in the network for a particular service event. The score management node then determines the quality score Q and its associated significance S in an action 602, which may be done in the manner described above for action 202.

A further action 604 illustrates that the score management node retrieves predefined values of the above-described parameters RTI and TTZ, e.g. from a suitable information storage. In a next action 606, the score management node calculates the above-described parameter SRR from the significance S determined in action 602 and the parameters RTI and TTZ retrieved in action 604. The parameter SRR may be calculated according to the above-described formula

SRR=S·RTI/TTZ

Another action 608 illustrates that the score management node reduces the significance S for this particular service event according to the calculated SRR after a period of time has elapsed, i.e. after one Reduction Time Interval, RTI, see also the example illustrated in FIG. 3. In a next action 610, the score management node calculates, or updates, the perception score P based on at least the quality score Q and the significance S reduced in action 608, thereby taking Q and S of the service event as well as the reduction of S into account. In this action the perception score P may be calculated from Q and S determined for one or more earlier service events, which was described above for action 206. Another action 612 illustrates that the score management node makes the calculated value of P available for service evaluation, thus corresponding to action 208 in FIG. 2.

The score management node then waits until the next RTI has expired, as shown by an action 614, and determined in another action 616 whether the parameter Time-to-Zero, TTZ has expired. If not, the procedure returns to action 608 for reducing S once more according to the SRR since this next RTI has expired. Actions 608-616 will be repeated until TTZ has expired and S has eventually been reduced to zero. In the latter case, i.e. “yes” in action 616, the score management node sets S to zero for this particular service event which will thereby not have any impact on the perception score P. This procedure of FIG. 6 may thus be performed for each new service event that occurs.

It was further mentioned above that the significance S may be reduced jointly for multiple service events at the same time, and that the perception score P may be calculated as an average of multiple partial perception scores Pp being calculated for different sets of service events with values of S within different separate intervals. An example of illustrates a procedure of how this might be performed FIG. 6 and with further reference to the block diagram in FIG. 8 which both illustrate operation of a score management node 800 in terms of actions and functional blocks, respectively. It is assumed that different memory lanes have been defined for different intervals of the significance S in the manner described above. In this example, n memory lanes have been defined for n intervals of S. These intervals may be separated by different significance thresholds such that if S of a service event is within a first interval below a first threshold the service event goes into memory lane 1, if S of another service event is within a second interval between the first threshold and a second threshold that service event goes into memory lane 2, and so forth.

In a first action 700, the score management node 800 receives network measurements v related to service events when the service is delivered to the user. Another action 702 illustrates that the score management node determines the quality score Q and its associated significance S for each service event, also illustrated by a functional block 800a. The score management node then selects a memory lane for each service event in an action 704, depending on within which interval the significance S falls, which is also illustrated as “streams” of Q and S in intervals 1, 2 . . . n from block 800a thus forming the different memory lanes 1, 2 . . . n. In other words, each service event is sorted, or classified, into one of the memory lanes 1, 2 . . . n, based on their respective values of S.

The score management node then determines the sum of all S values, i.e. the S sum, for the different memory lanes and corresponding S intervals, as shown in an action 706. In this example it is assumed that multiple service events are placed in each memory lane. In a further action 708, the score management node 800 calculates the above-described parameter SRR for each memory lane and corresponding S interval, based on the respective S sum determined in action 706 by using the above-described formula for calculating SRR from S, RTI and TTZ, also illustrated by functional block 800b. Another action 710 illustrates that the score management node further reduces the S sum jointly for each memory lane and corresponding S interval over time according to the respective SRRs calculated in action 708, also illustrated by functional block 800c. Action 710 may be performed for each memory lane in the manner described above for action 608. In a next action 712, the score management node calculates a partial perception score Pp for the service events in each memory lane and corresponding S interval based on at least the corresponding quality scores Q and S sum reduced in action 710. FIG. 8 illustrates that partial perception scores Pp1, Pp2 . . . Ppn are calculated after the reduction of the S sums. Finally, the score management node determines a total perception score P as an average of the partial perception scores Pp1, Pp2 . . . Ppn, as illustrated in an action 714 and a functional block 800d, respectively. This action may be performed in the manner described for FIGS. 2 and 5.

While the solution has been described with reference to specific exemplifying embodiments, the description is generally only intended to illustrate the inventive concept and should not be taken as limiting the scope of the solution. For example, the terms “score management node”, “perception score”, “quality score”, “significance”, “Significance Reduction Rate, SRR”, “Reduction Time Interval, RTI”, “Time to Zero, TTZ”, “partial perception score”, and memory lane” have been used throughout this disclosure, although any other corresponding entities, functions, and/or parameters could also be used having the features and characteristics described here. The solution is defined by the appended claims.

1. A method performed by a score management node for supporting service evaluation by obtaining a perception score reflecting an individual user's experience of a service delivered by means of a telecommunication network, the method comprising:
receiving network measurements related to service events when the service is delivered to the user,
determining, for each service event, a quality score reflecting the user's perception of quality of service delivery and an associated significance reflecting the user's perception of importance of the service delivery, based on said network measurements,
reducing the determined significance over time according to a Significance Reduction Rate, SRR, reflecting the user's fading memory of the service events, and
calculating the perception score as an average of the quality scores weighted by their associated significances, wherein the calculated perception score is made available for use in the service evaluation.

2. The method according to claim 1, wherein the score management node reduces the significance according to the SRR at regular intervals over time.

3. The method according to claim 2, wherein the score management node calculates the SRR from a predefined Reduction Time Interval, RTI, and a predefined Time to Zero parameter, TTZ, as
SRR=S·RTI/TTZ
where S is the significance, RTI is a time interval between reductions of the significance S and TTZ is a time from said service events until the significance S reaches zero.

4. The method according to claim 3, wherein the score management node reduces the determined significance S by subtracting SRR after each RTI.

5. The method according to claim 1, wherein the score management node reduces the significance of each respective service event separately over time according to the SRR, and calculates the perception score as an average of the quality scores for the service events weighted by their associated separately reduced significances.

6. The method according to claim 1, wherein the score management node reduces a sum of the significances over time and calculates the perception score as a sum of the quality scores for the service events weighted by the reduced sum of significances.

7. The method according to claim 6, wherein the score management node updates the perception score after a new service event as a weighted average of the perception score and a quality score of the new service event, adds the significance of the new service event to the sum of significances and updates the SRR based on the new sum of significances which is reduced over time according to the updated SRR.

8. The method according to claim 6, wherein the score management node calculates at least a first partial perception score for service events with significance below a predefined significance threshold and a second partial perception score for service events with significance above the predefined significance threshold, and calculates the perception score as an average of the at least first and second partial perception scores.

9. The method according to claim 8, wherein the score management node calculates multiple partial perception scores for different service events with significance within different intervals, based on corresponding partial sums of the significances which are reduced over time according to respective SRRs, and calculates the perception score as an average of the multiple partial perception scores.

10. The method according to claim 1, wherein the score management node calculates the perception score PN for N service events as
$${P}_{N} = \frac{{\sum }_{n = 1}^{N} {Q}_{n} {S}_{n}}{{\sum }_{n = 1}^{N} {S}_{n}}$$
where Qₙ is the quality score for each service event n and Sₙ is the associated significance for said service event n.

11. The method according to claim 1, wherein the network measurements are related to any of: the time needed to download data, the time from service request until delivery, call drop rate, data rate, and data error rate.

12. The method according to claim 1, wherein the score management node receives the network measurements in a message according to the hyper-text transfer protocol http or the file transfer protocol ftp.

13. A score management node arranged to support service evaluation by obtaining a perception score reflecting an individual user's experience of a service delivered by means of a telecommunication network, the score management node comprising a processor and a memory containing instructions executable by the processor, whereby the score management node is configured to:
receive network measurements related to service events when the service is delivered to the user,
determine, for each service event, a quality score reflecting the user's perception of quality of service delivery and an associated significance reflecting the user's perception of importance of the service delivery, based on said network measurements,
reduce the determined significance over time according to a Significance Reduction Rate, SRR, reflecting the user's fading memory of the service events, and
calculate the perception score as an average of the quality scores weighted by their associated significances, wherein the calculated perception score is made available for use in the service evaluation.

14. The score management node according to claim 13, wherein the score management node is configured to reduce the significance according to the SRR at regular intervals over time.

15. The score management node according to claim 14, wherein the score management node is configured to calculate the SRR from a predefined Reduction Time Interval, RTI, and a predefined Time to Zero parameter, TTZ, as
SRR=S·RTI/TTZ
where S is the significance, RTI is a time interval between reductions of the significance S and TTZ is a time from said service events until the significance S reaches zero.

16. The score management node according to claim 15, wherein the score management node is configured to reduce the determined significance S by subtracting SRR after each RTI.

17. The score management node according to claim 13, wherein the score management node is configured to reduce the significance of each respective service event separately over time according to the SRR, and calculates the perception score as an average of the quality scores for the service events weighted by their associated separately reduced significances.

18. The score management node according to claim 13, wherein the score management node is configured to reduce a sum of the significances over time and calculates the perception score as a sum of the quality scores for the service events weighted by the reduced sum of significances.

19. The score management node according to claim 18, wherein the score management node is configured to update the perception score after a new service event as a weighted average of the perception score and a quality score of the new service event, add the significance of the new service event to the sum of significances, and to update the SRR based on the new sum of significances which is reduced over time according to the updated SRR.

20. The score management node according to claim 18, wherein the score management node is configured to calculate at least a first partial perception score for service events with significance below a predefined significance threshold and a second partial perception score for service events with significance above the predefined significance threshold, and to calculate the perception score as an average of the at least first and second partial perception scores.

21. The score management node according to claim 20, wherein the score management node is configured to calculate multiple partial perception scores for different service events with significance within different intervals, based on corresponding partial sums of the significances which are reduced over time according to respective SRRs, and to calculate the perception score as an average of the multiple partial perception scores.

22. The score management node according to claim 13, wherein the score management node is configured to calculate the perception score PN for N service events as
$${P}_{N} = \frac{{\sum }_{n = 1}^{N} {Q}_{n} {S}_{n}}{{\sum }_{n = 1}^{N} {S}_{n}}$$
where Qₙ is the quality score for each service event n and Sₙ is the associated significance for said service event n.

23. The score management node according to claim 13, wherein the network measurements are related to any of: the time needed to download data, the time from service request until delivery, call drop rate, data rate, and data error rate.

24. The score management node according to claim 13, wherein the score management node is configured to receive the network measurements in a message according to the hyper-text transfer protocol http or the file transfer protocol ftp.

25. A computer program storage product comprising instructions which, when executed on at least one processor, cause the at least one processor to carry out the method according to claim 1.
